(19) United States
(12) Patent Application Publication
(10) Pub. No.: US 2024/0152562 A1
(43) Pub. Date: May 9, 2024

(54) SYSTEMS AND METHODS FOR IMPROVED SEARCH AND INTERACTION WITH AN ONLINE PROFILE

(71) Applicant: BOLD Limited, Hamilton (BM)

(72) Inventors: James Frederic FREUNDLICH, San Juan, PR (US); John GLASE, San Juan, PR (US)

(73) Assignee: BOLD Limited, Hamilton (BM)

(21) Appl. No.: 18/160,166

(22) Filed: Jan. 26, 2023

Related U.S. Application Data
(60) Provisional application No. 63/382,272, filed on Nov. 3, 2022.

(51) Int. Cl. G06F 16/9535; G06F 16/2457; G06F 16/9538

(52) U.S. Cl. CPC G06F 16/9535; G06F 16/24578; G06F 16/9538

(57) ABSTRACT

Systems and methods for searching online profiles on an application portal is disclosed. One method may include: receiving, at an application portal, a search request from a user; retrieving, by the one or more processors and from one or more accessible databases associated with the application portal, one or more online profiles that are determined to match the category selection and the keyword indication; assigning, utilizing a ranking algorithm, each of the one or more online profiles a rank, wherein the rank is assigned based on one or more ranking criteria; presenting, on a search results screen, a listing of previews of the one or more online profiles to the user in a ranked order based on the assigned rank, wherein each of the previews contains a subset of information contained in the one or more online profiles.

### CROSS-REFERENCE TO RELATED APPLICATIONS

This application claims the benefit of priority from U.S. Provisional Patent Application No. 63/382,272, filed Nov. 3, 2022, which is hereby incorporated by reference herein in its entirety.

### TECHNICAL FIELD

Various embodiments of the present disclosure relate generally to the field of online profiles, and, more particularly, to systems and methods that optimize interactions between profile viewers and profile creators.

### BACKGROUND

The entire disclosure of commonly owned U.S. Patent Application No. 63/337,887 is incorporated by reference herein except for any definitions, subject matter disclaimers or disavowals, and except to the extent that the incorporated material is inconsistent with the express disclosure herein, in which case the language in this disclosure controls.

Online profiles, or “social cards”, as those described throughout U.S. Patent Application No. 63/337,887, may enable individuals to provide more information about themselves and their capabilities than may conventionally be conveyed through a traditional résumé and/or curriculum vitae (CV). This expansive information may correspondingly aid a reviewer of the online profile in various decisions they need to make (e.g., with respect to hiring for a particular job opening). The systems that support these profiles may contain additional functionalities, as further described herein, that may optimize interaction experience with the profiles with respect to the performance of various tasks (e.g., job searching, job hiring, etc.).

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for interacting with an online profile.

In one aspect, a method for searching online profiles on an application portal is disclosed. The method includes: receiving, by one or more processors and at an application portal, a search request from a user, wherein the search request comprises a category selection and a keyword indication; retrieving, by the one or more processors and from one or more accessible databases associated with the application portal, one or more online profiles that are determined to match the category selection and the keyword indication; assigning, by the one or more processors and utilizing a ranking algorithm, each of the one or more online profiles a rank, wherein the rank is assigned based on one or more ranking criteria; presenting, by the one or more processors and on a search results screen, a listing of previews of the one or more online profiles to the user in a ranked order based on the assigned rank, wherein each of the previews contains a subset of information contained in the one or more online profiles.

In another aspect, a system for searching online profiles on an application portal is disclosed. The system includes: at least one database; and a server in network communication with the at least one database, the server comprising at least one processor configured to perform operations including: receiving, at an application portal, a search request from a user, wherein the search request comprises a category selection and a keyword indication; retrieving, from one or more accessible databases associated with the application portal, one or more online profiles that are determined to match the category selection and the keyword indication; assigning, utilizing a ranking algorithm, each of the one or more online profiles a rank, wherein the rank is assigned based on one or more ranking criteria; and presenting, on a search results screen, a listing of previews of the one or more online profiles to the user in a ranked order based on the assigned rank, wherein each of the previews contains a subset of information contained in the one or more online profiles.

In yet another aspect, a non-transitory computer-readable medium storing computer-executable instructions which, when executed by at least one processor of a server in network communication with at least one database, cause the at least one processor to perform operations including: receiving, at an application portal, a search request from a user, wherein the search request comprises a category selection and a keyword indication; retrieving, from one or more accessible databases associated with the application portal, one or more online profiles that are determined to match the category selection and the keyword indication; assigning, utilizing a ranking algorithm, each of the one or more online profiles a rank, wherein the rank is assigned based on one or more ranking criteria; and presenting, on a search results screen, a listing of previews of the one or more online profiles to the user in a ranked order based on the assigned rank, wherein each of the previews contains a subset of information contained in the one or more online profiles.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary online profile, according to one or more embodiments.

FIGS. 2A-2B depict an online profile search screen on an application platform, according to one or more embodiments.

FIGS. 3A-3C depict an exemplary search results page of an application portal, according to one or more embodiments.

FIG. 4 depicts a listing of similar profile options resident on an exemplary online profile page, according to one or more embodiments.

FIG. 5 depicts a portion of an exemplary online profile, according to one or more embodiments.

FIG. 6 depicts an exemplary contact form of an application portal, according to one or more embodiments.

FIG. 7 depicts an exemplary flowchart of a method for searching online profiles on an application portal, according to one or more embodiments.

FIG. 8 depicts an exemplary computing device that may execute the techniques described herein, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, systems and methods for interacting with an online profile are described.

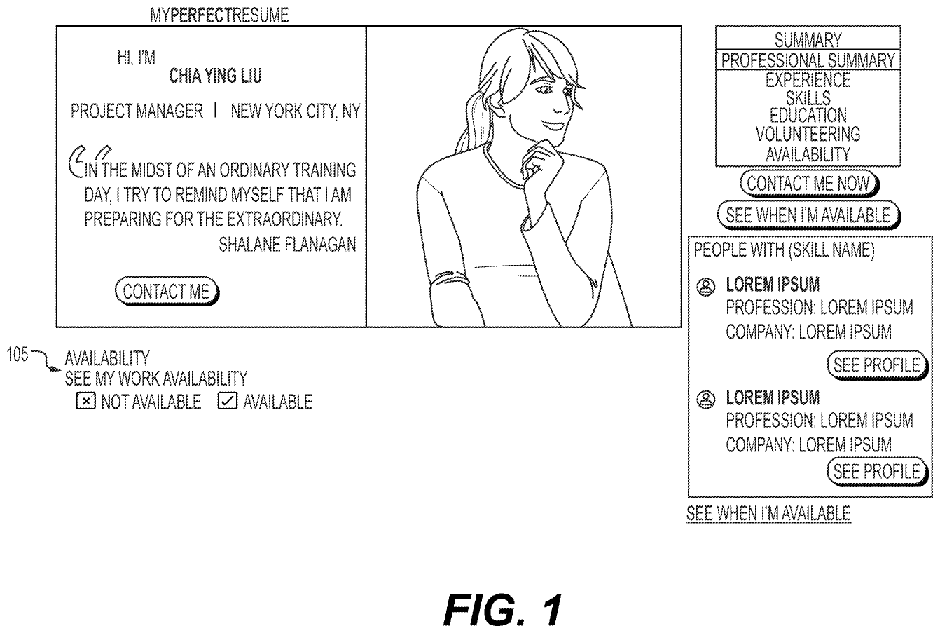

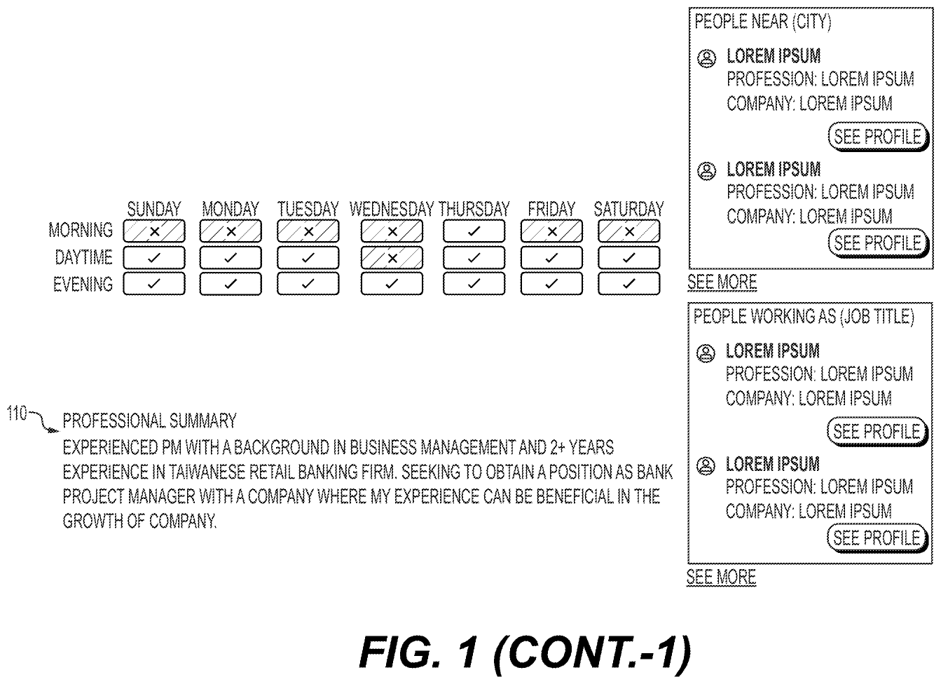

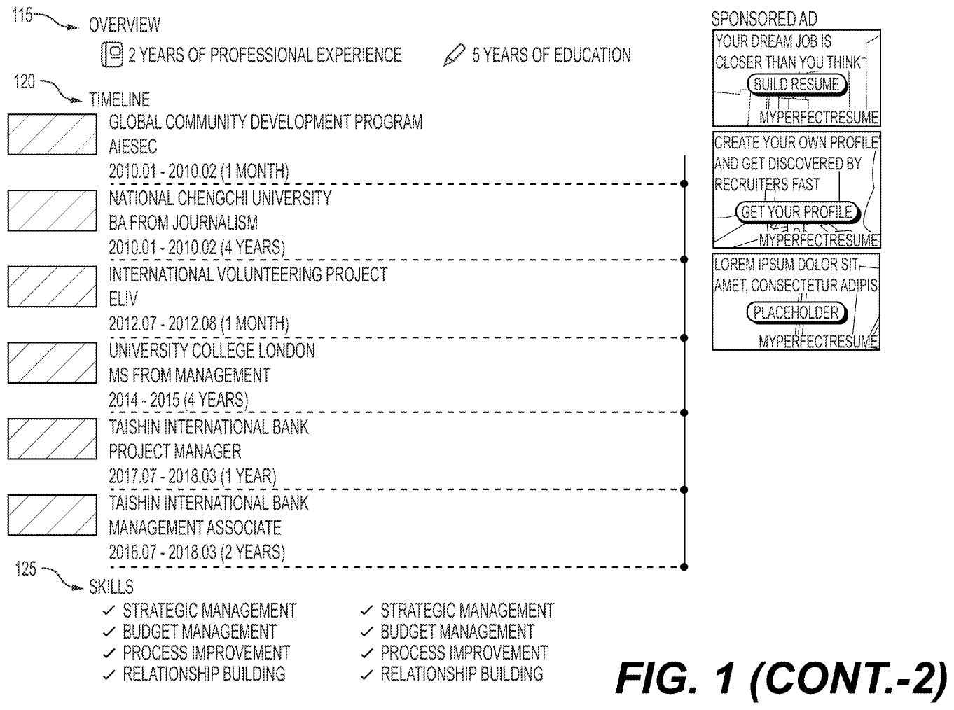

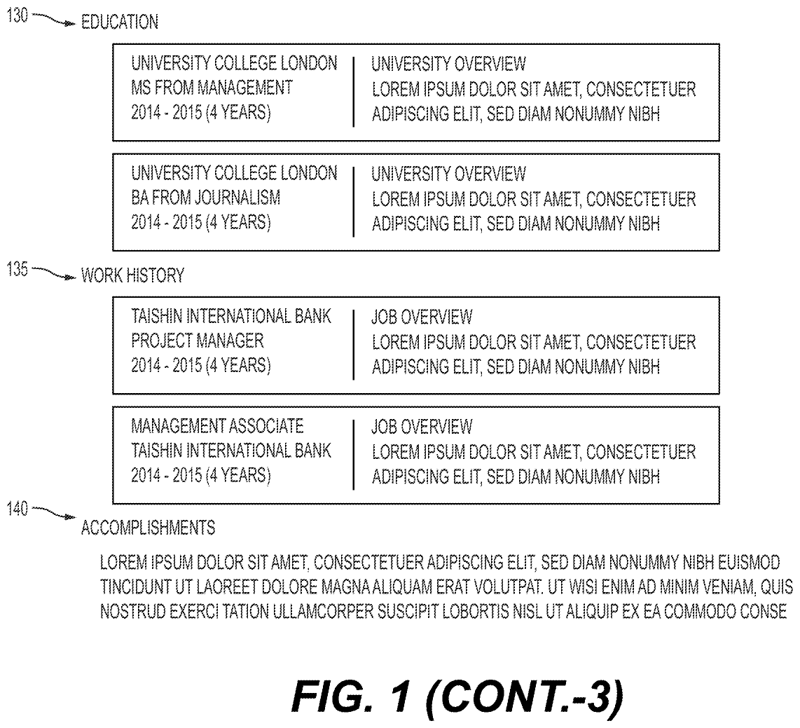

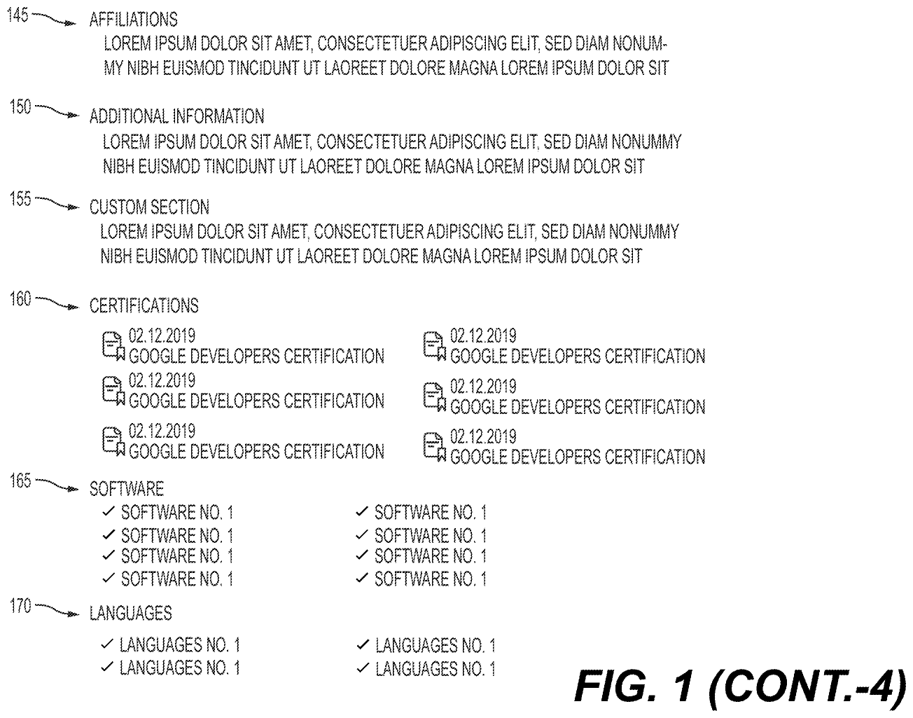

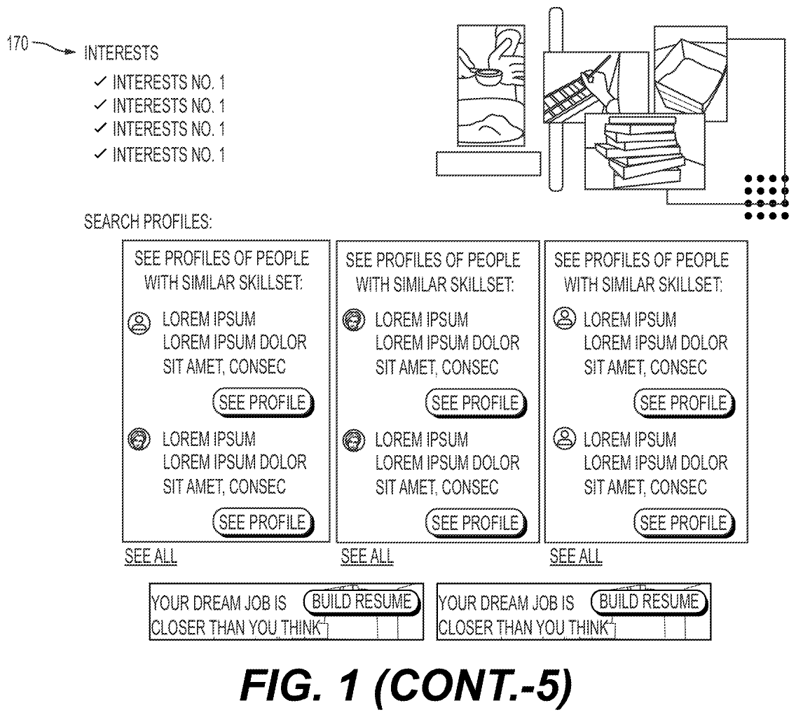

In an embodiment, individuals may be able to interact with a web-based portal (e.g., a website, application, etc.) to construct an online profile, as described in U.S. Patent Application No. 63/337,887. The online profile may contain various types of information about the individual. For instance, referring now to FIG. 1, an exemplary online profile of a sample user of the portal is provided. The online profile may contain a plurality of different sections that contain information about the user, e.g., an Availability section 105, a Professional Summary section 110, an Overview section 115, a Timeline section 120, a Skills section 125, an Education section 130, a Work History section 135, an Accomplishments section 140, an Affiliations section 145, an Additional Information section 150, a Custom section 155, a Certifications section 160, a Software section 165, a Languages section 170, Interests section 175, and more. To facilitate the online profile construction process, the portal may contain a digital profile construction assistant that may guide a new user through the construction of their online profile. For instance, the profile construction assistant may initially present to the new user a plurality of ready-made template designs that they may choose from to establish the look, feel, and/or layout of their online profile. The profile construction assistant may thereafter guide a user through each section of the online profile, providing explanations and/or examples along the way. Additionally or alternatively to the foregoing, the profile construction assistant may dynamically construct all, or portions of, the online profile itself by, for example, leveraging available context data associated with the new user. For example, given knowledge of a new user's education, experience, hobbies, interests, etc., the profile construction assistant may dynamically choose a banner image that most closely matches the spirit of the foregoing data points (e.g., if the new user's past experience and interest revolve around boating, the profile construction assistant may suggest a banner containing waves in the ocean). Once the online profile is created, it may be accessible to other users of the portal (i.e., based on online profile permissions). Additionally, the user may utilize the online profile to directly apply to job listings in lieu of a traditional résumé, as further described herein.

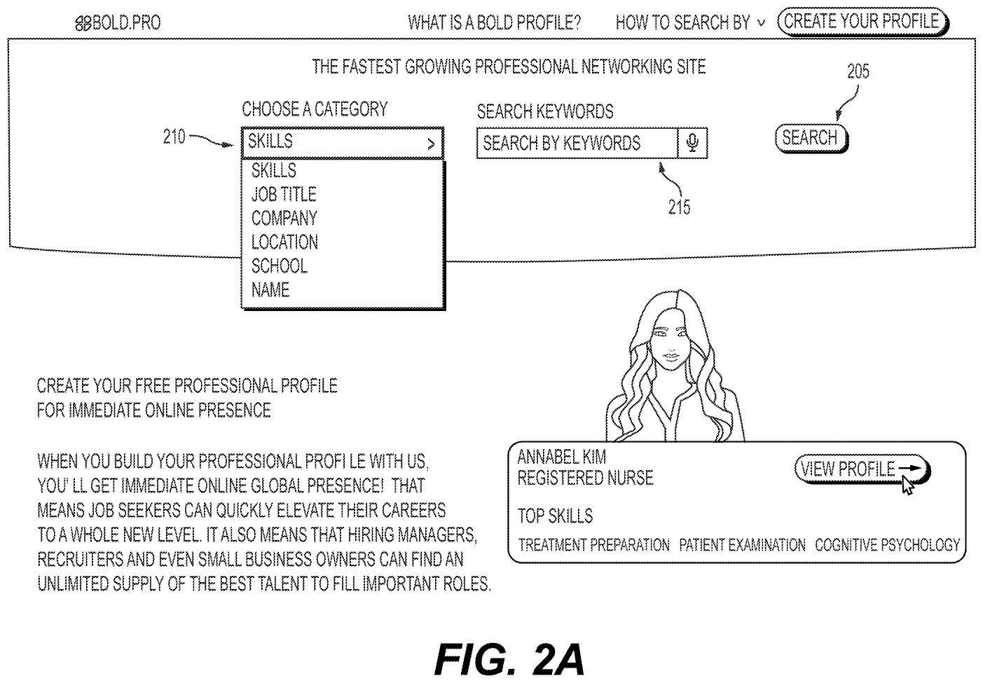

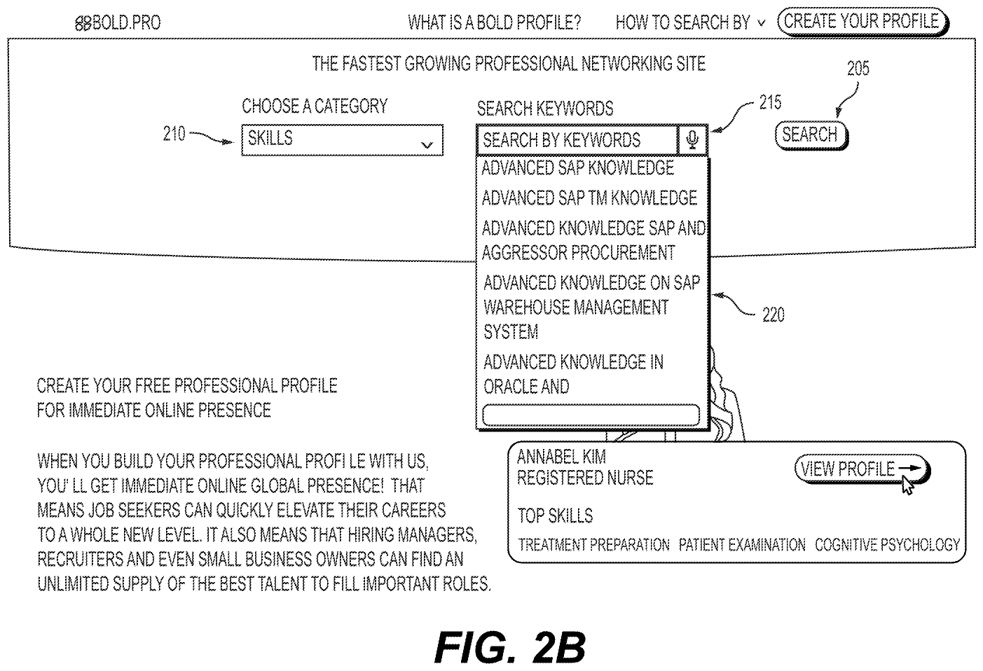

The system of the embodiments may enable profile viewers to conduct searches of online profiles via interaction with the web-based portal. More particularly, the profile viewers may provide a search request that designates a particular category of interest, along with one or more keywords associated with the category, and the system may return, as a results listing, one or more online profiles that meet some or all of the criteria contained in the search request. For example, referring now to FIG. 2A, an exemplary graphical user interface (GUI) of an online portal is provided. The portal may contain a search feature 205 that profile viewers may utilize to search through all of the online profiles accessible by the portal. In this regard, the portal may have access to and may conduct a search across a plurality of databases that may contain various types of user data (e.g., online profile data, traditional resume data, “enhanced documents” as described in U.S. Patent Application No. 63/337,887, etc.). In an embodiment, a profile viewer may interact with a category selection menu 210 to select a category that will be utilized to better tailor their search for more relevant profiles. In an embodiment, potential categories may include skills, job title, company, location, school, and name. It is important to note that these categories are non-limiting and other categories not explicitly listed here, or illustrated in FIG. 2A, may be selected. In an embodiment, the profile viewer may additionally provide, in a keyword input field 215, one or more specific keywords that they believe a desired online profile may likely contain. For instance, referring now to FIG. 2B, the profile viewer may be interested in hiring a candidate who has skills in Advanced SAP Knowledge (i.e., a type of Enterprise Resource Planning (ERP) system). Accordingly, the profile viewer may select the “skills” category from the category selection menu 210 and may also provide the keywords “Advanced Sap Knowledge” to the keyword input field 215 (e.g., via touch input, typing input, voice input, etc.). In an embodiment, the system may be configured to provide, during or after keyword input provision, alternative keyword suggestions in a dropdown suggestion menu 220. Each of the alternative suggestions may correspond to a similar phrasing or representation of the keyword(s). For instance, given the keywords “Advanced Sap Knowledge”, potential alternative keyword suggestions may include “Advanced SAP TM Knowledge”, “Advanced Knowledge SAP and Aggressor Procurement”, “Advanced Knowledge on SAP Warehouse Management System”, etc. In some embodiments, the keyword provided to the keyword input field 215 may be automatically completed by the online portal. For example, upon a portion of the keyword being input by the user, the online portal may search a keyword list for keywords or key phrases that contain the potion of the keyword that has been provided by the user, and may suggest those keywords or key phrases to the user so that the user may complete the partial keyword so far provided in the keyword input field 215 by selecting the suggested keywords or key phrases. Notably, the keywords or key phrases contained in the keyword list may be extracted from online profiles and/or enhanced documents being managed by the online portal. In a similar vein, a profile creator may also utilize the search features of the portal to discover and/or apply for job opportunities.

In an embodiment, subsequent to constructing and submitting the search request to the system, the system may generate a listing of search results. More particularly, the system may leverage one or more ranking algorithms in the identification and/or the presentation of online profiles in response to an online profile search. More particularly, higher ranked profiles may be more prominently displayed to a searcher than lower ranked profiles (e.g., by appearing earlier in a search results list, etc.). In an embodiment, the one or more ranking algorithms may leverage one or more ranking criteria to facilitate the ranking process. For instance, in an embodiment, the search results may be ranked based upon the proportion and/or number of keyword matches between the search inquiry and the content contained in the online profiles. More particularly, those profiles containing a greater proportion and/or number of shared keyword matches with the search inquiry may be ranked higher than other profiles that contain fewer shared keyword matches. Additionally or alternatively, in another embodiment, the search results may be ranked based upon content robustness, wherein a more robust or complete profile is ranked higher than a less complete profile. In this regard, the system of the embodiments may identify the number of completed sections in the online profile, volume of information in each section, etc., and facilitate the ranking based on these metrics. Additionally or alternatively, in another embodiment, the search results may be ranked based upon the subscription status of the profile owner (e.g., wherein a profile owner subscribed to more services on the application portal may have their online profile ranked higher than another profile owner who is subscribed to less services on the application portal). Additionally or alternatively, in another embodiment, the search results may be ranked based upon a popularity of the online profiles. More particularly, those online profiles that have received more overall views, or more views in a predetermined time period (e.g., in the past week, month, year, etc.), may be ranked higher than those profiles that receive less traffic. Additionally or alternatively, in another embodiment, the ranking of the search results may further be affected by other factors such as publication date of the online profiles (e.g., newer online profiles may be higher ranked over older profiles), update status of the online profiles (e.g., more recently updated online profiles may be higher ranked than non-updated profiles, etc.), recent activity of the online profiles (e.g., online profiles that are more frequently logged into and/or that are more frequently submitted for job listings may be higher ranked than those having minimal activity or utilization), and other factors not explicitly listed here.

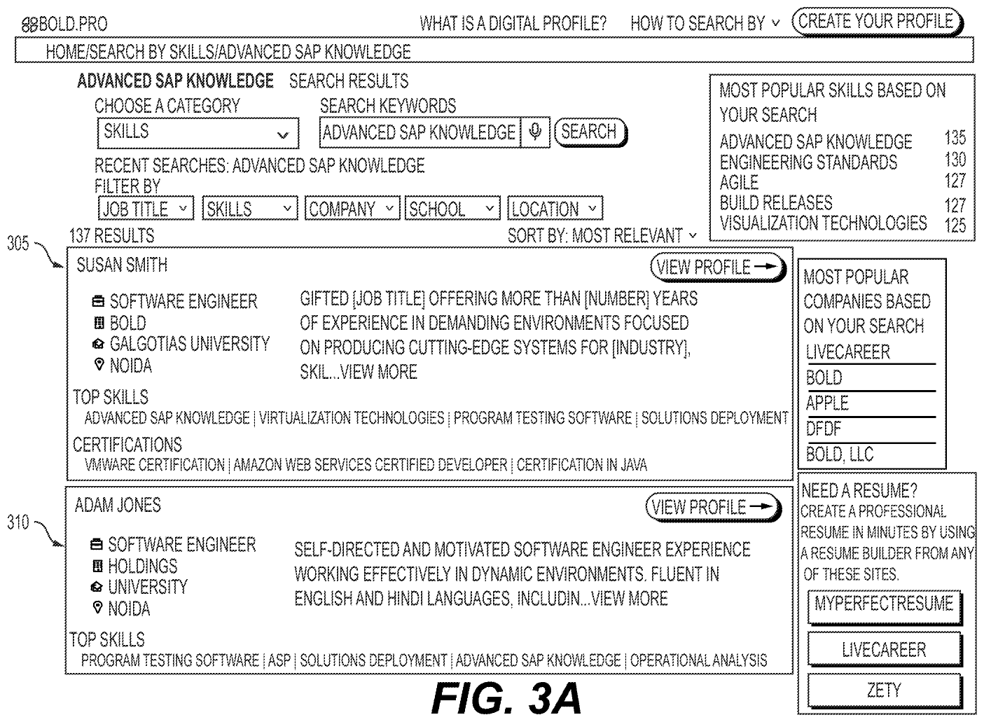

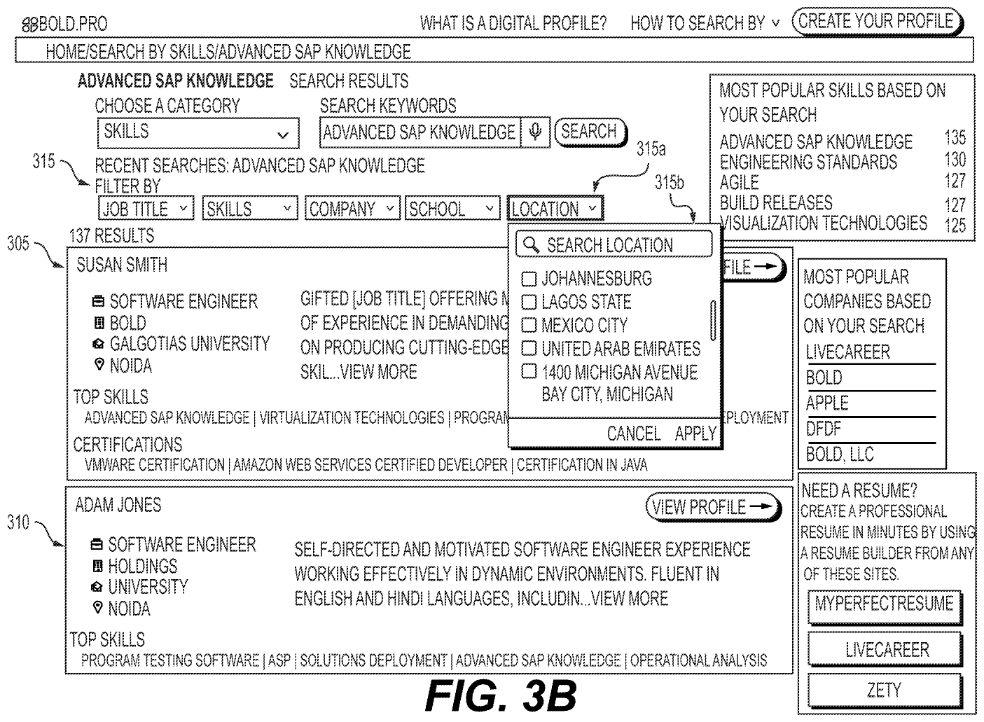

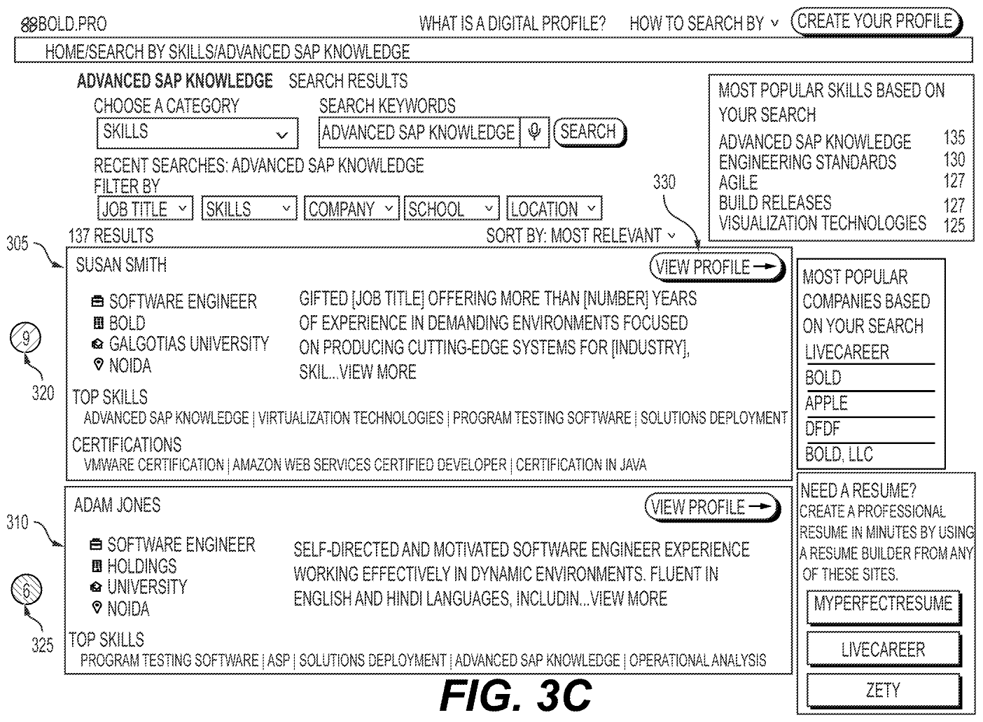

Referring now to FIG. 3A, an exemplary subset of search results corresponding to the search request initiated by the profile viewer in FIGS. 2A-2B are provided. In an embodiment, each of the illustrated search results, 305 and 310, may contain a preview of a full profile that the system identifies as being related to the search request. In an embodiment, each preview may contain one or more pieces of information associated with a profile owner, such as a profile owner's: name, educational history, current employment, current location, top skills, certifications, summary statement, and the like. Referring now to FIG. 3B, a profile viewer may be able to further narrow the search results by applying one or more filters from a filters menu 315. For instance, a profile viewer may choose to filter the original search results by job title, skills, company, school, and/or location. In the representative example provided in FIG. 3B, a profile viewer chose to filter the original search results by location. Upon selecting the “location” filter sub-menu 315a, the profile viewer may be presented with a drop-down list 315b that they may navigate to choose a particular location. Upon selection of a location, the original search results may be narrowed to only include those listings that match the category, keywords, and designated location.

In an embodiment, the system may be able to provide a visual indicator in association with each profile listing that may quickly inform a profile viewer about the compatibility of the profile owner with a particular job that the profile viewer (e.g., an employer) is looking to hire for. More particularly, some employers may only wish to explore the in-depth details of those profiles that are a likely fit for a job opening. Accordingly, the system of the embodiments may be able to compare the data in the profile owner's profile to the requirements/qualifications outlined in a job listing (e.g., as provided by the profile viewer to the system) and, based on this comparison, make a determination of how likely the applicant is to be hired for that job. The result of this determination (i.e., the compatibility of an online profile to a job opportunity) may manifest as a visual indicator located proximate to the online profile preview. In an embodiment, the visual indicator may be a number (e.g., a number between 1 to 10 where a higher number indicates a greater likelihood of being hired), a color (e.g., a green, yellow, or red color, where green indicates a high hiring likelihood and red indicates a low hiring likelihood) and/or shades thereof (e.g., a darker shade of green may indicate a greater hiring likelihood than a lighter shade of green), an emoticon (e.g., a smiling face may indicate a greater hiring likelihood than a frowning face), an animation, a combination of any of the foregoing, and the like. In a similar embodiment, another visual indicator may also be presented that provides an indication of how compatible a job listing is with an applicant's skillset, availability, compensation goals, etc. This secondary visual indicator may be presented using the same or different means as the first visual indicator, as previously described above.

Referring now to FIG. 3C, each of the search results, 305 and 310, may contain a visual indicator of hiring compatibility 320 and 325 respectively. Each of the indicators of hiring compatibility 320, 325 contains a color (e.g., red, yellow, green, etc.) and a number associated with it (e.g., a number from 1-10, etc.). The color may provide a quick reference for how closely an online profile matches the job criteria of the profile viewer (e.g., green may indicate high compatibility, yellow may indicate moderate compatibility, red may indicate low compatibility, etc.) and the number presented within the color may serve to differentiate two online profiles in the same color category (e.g., an online profile having a green-9 indication may be more compatible than an online profile having a green-7 indication, etc.). As briefly alluded to above, in certain embodiments, the indicator may contain no number at all and the differences in hiring compatibility within the same color category may be represented by color shading (e.g., a deeper shade of green may be representative of an online profile that is more compatible than an online profile associated with a lighter shade of green, etc.). Similarly, in other embodiments, the indicator may only contain a number without any color. Accordingly, given the foregoing, the online profile 305 may be more compatible with the hiring criteria of the profile viewer than online profile 310 because the visual indicator 320 associated with online profile 305 contains both a higher number and a more favorable color designation (i.e., a green color represented in these black and white drawings by rising diagonal dashes) than the visual indicator 325 associated with online profile 310 (i.e., containing a yellow color represented in these black and white drawings as by falling diagonal dashes).

The foregoing may also be applicable to profile owners that are searching through a series of job listings. For instance, the system may be configured to provide, in response to a user-conducted search, a listing of job opportunities that a user may explore. In an embodiment, a job listing may be one that appears on the web-based portal (e.g., as part of a search) (not illustrated) or, alternatively, may be one that is resident at another location. For instance, with respect to the latter, a user may copy the details of a job listing from another website and paste those details into an input field of the online portal. The system may subsequently analyze this data and make a compatibility/hiring determination. Additionally or alternatively, comparison may be performed with respect to prior candidates that have been accepted and/or denied the job described in the job listing, and the similarity of the applicant to the successful and/or unsuccessful candidates may be considered in determining the applicant's likelihood of being hired. The result of the foregoing determinations may manifest as a visual indicator (as previously described above) that provides a clue to the profile owner how compatible their online profile is to the published requirements of a certain job listing.

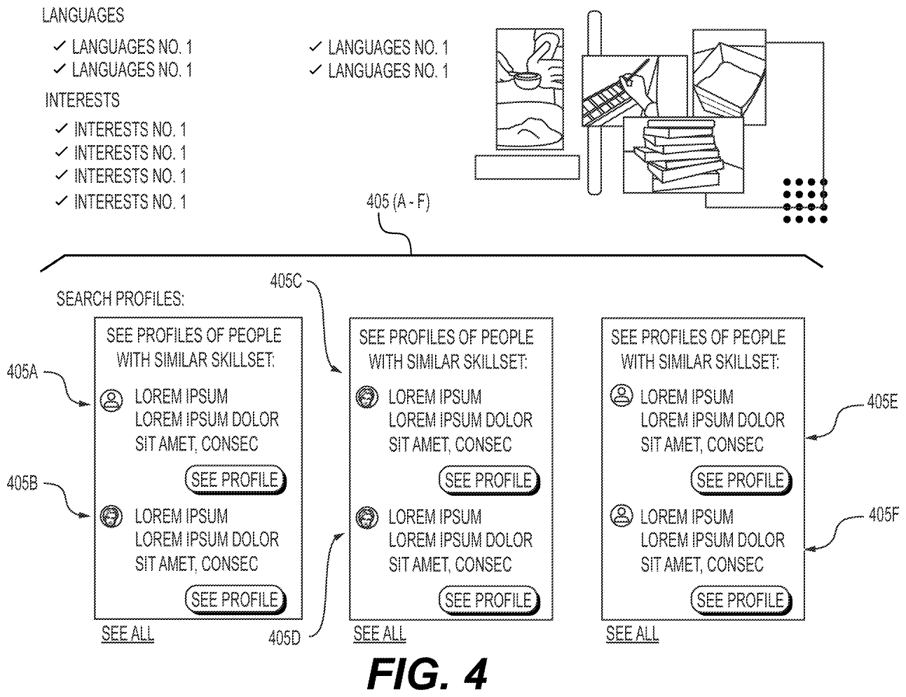

In an embodiment, subsequent to selection by a profile viewer to view a full profile associated with one of the search results (e.g., via selection of a “view profile” icon 330 illustrated in FIG. 3C), a profile viewer may be presented with options to view one or more other profiles that may be similar to the currently viewed profile. In the context of this application, a “similar” profile may be a profile that shares a similar: educational background, skill set, certification status, work history, indicated availability, any combination of the foregoing, and the like. The system may identify these similar profiles via leveraging one or more word and/or context matching algorithms across some or all of the online profiles stored in the databases to identify those profiles that share a predetermined amount of similar data as the currently viewed profile. In an embodiment, these options may be presented to the profile viewer on the same page on which they are viewing the current profile (e.g., at a peripheral portion of the online profile such as at the bottom edge of the online profile, etc.). For example, referring now to FIG. 4, a plurality of exemplary similar profile options 405A-405F are provided. More particularly, each of the similar profile options 405A-405F contain listings of other profiles that have been identified as having a similar skillset to the currently viewed profile. In this example, the plurality of similar profile options are presented to the profile viewer at the bottom portion of a currently viewed profile page. Upon selection of any of these similar profiles, the profile viewer may be redirected to the chosen profile.

In an embodiment, the system may contain adjustable settings that users may toggle to restrict the ability of certain parties (e.g., their employers, colleagues, professional contacts/acquaintances, friends, family, etc.) to view their profile contents and/or profile activity on the platform. For instance, a profile owner may toggle a fully private mode in which the contents of their profile and their viewing activity are not accessible to the public. In another example, a profile owner may assign group designations to certain viewing parties and thereafter allocate profile access permissions to each of these groups. For instance, a profile owner may assign all profiles associated with their current employer (e.g., the profile of their boss, the profiles of their colleagues, etc.) to a “workplace” group and restrict the ability of any profile assigned to the workplace group to access the profile owner's profile and/or see their activity. In yet another example, a profile owner may be able to make a selection of one or more current and/or past companies that the user may or may not have been associated with, and prevent other users currently or previously associated with (e.g., employed by) the selected one or more companies from accessing the user's profile. In yet another example, a profile owner may be able to designate various time periods during the day, or various time periods that span an extended period of time (e.g., multiple days, weeks, months, etc.), during which viewership of the activity on their profile is restricted to only allotted individuals. In yet another example, the system may be able to make more dynamic restrictions based upon the activity of the profile owner. More particularly, the system may be trained to identify those activities that a profile owner engages in that they may not want certain profile viewers to see (e.g., jobs that a profile owner has applied to, individual that a profile owner has connected with, announcements or status updates that a profile owner has posted, etc.). Thereafter, the system may dynamically enable a profile viewer to see some of the activities of the profile owner while simultaneously restricting the profile viewer from seeing other activity that the system anticipates the profile owner does not want shared.

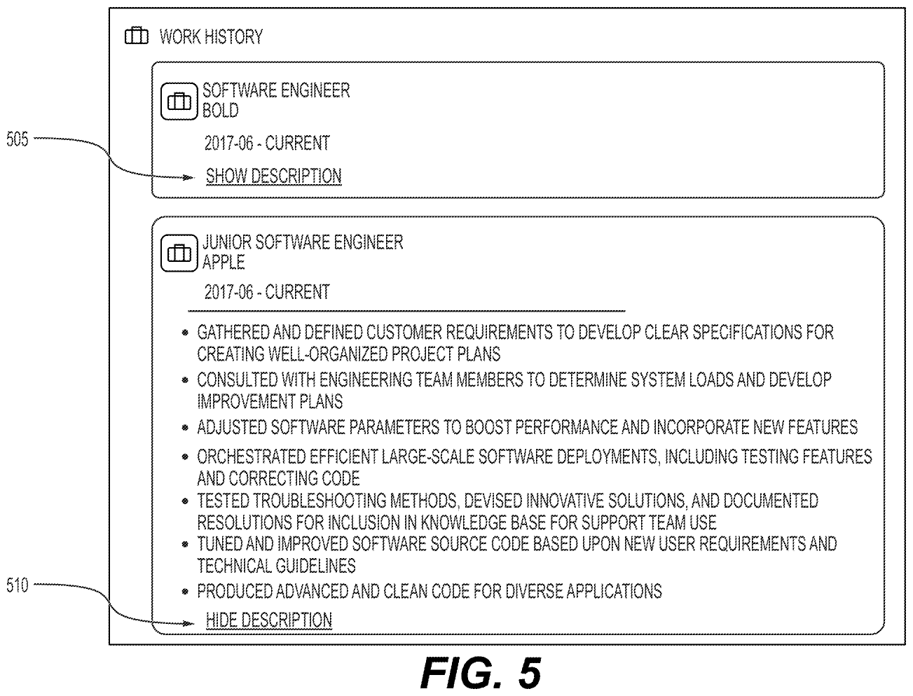

In an embodiment, the system of the embodiments may be able to track and capture various types of analytical data in relation to interaction events with an online profile. For example, the system may be able to monitor and record: the number of times a profile appeared in a search results listing, the volume of visitation traffic (i.e., views on the profile page) that a profile receives, the types of interactions a viewing party has with a profile page (e.g., the length of time a viewer spends on the profile page, the links on the profile page that were interacted with, the sections and/or sub-sections on the profile page that were viewed or interacted with, the number of times a unique tracking link is clicked on by third parties, and the like), and the like. In an embodiment, the system can provide notifications and/or recommendations to the profile owner based on this tracking data. For example, responsive to identifying that profile viewers spend very little time on their profile page, the system may recommend that the profile owner increases the robustness of their online profile (e.g., by completing additional sections of the online profile). As another example, responsive to identifying that a particular section of the profile owner's profile is receiving more attention than other sections (e.g., by identifying that profile viewers are “expanding” the information contained in all or portions of a profile section (e.g., by interacting with the icons 505 or 510), as illustrated in FIG. 5), the system may recommend that the user emphasize that section more (e.g., by moving it higher up in the profile and/or to a more visible location, including more relevant information, etc.). Similarly, responsive to identifying that a particular section of the user's profile is receiving little to no attention, the system may recommend that the user bolster the content in that section or to remove it entirely.

In an embodiment, the system may be able to provide feedback to profile owners that are job applicants. For instance, the system may be configured to provide guidance (e.g., in the form of recommendations, etc.) to job applicants that may have applied for and subsequently been denied a particular position. To facilitate this guidance provision, the system may dynamically compare a hired candidate's profile with that of a denied candidate's profile to identify the differences between the two. Thereafter, based on this comparison, the system may provide one or more recommendations for actions that a denied candidate can take (e.g., pursue additional education, obtain additional work experience, acquire specific certifications, etc.) to more closely align their user profile with that of the hired candidate's profile so that they may improve their chances in a future job pursuit. Additionally or alternatively, the system may dynamically connect a denied job candidate with certain resources that may help them improve their chances of obtaining a similar job in the future. For example, the system may identify that a candidate was likely denied for a position due to not having certain certifications. Thereafter, the system may dynamically provide a listing of online courses that the candidate can take to acquire the knowledge/skills needed to obtain the relevant certification. In another embodiment, the system may also provide feedback to job applicants that did obtain the job. For instance, the system may be able to identify areas in the job applicant's experience that may be considered “weak” or “below average” as compared to other individuals that have the same or similar job and may provide recommendations to that individual to obtain knowledge and/or experience in those weaker areas prior to starting the job.

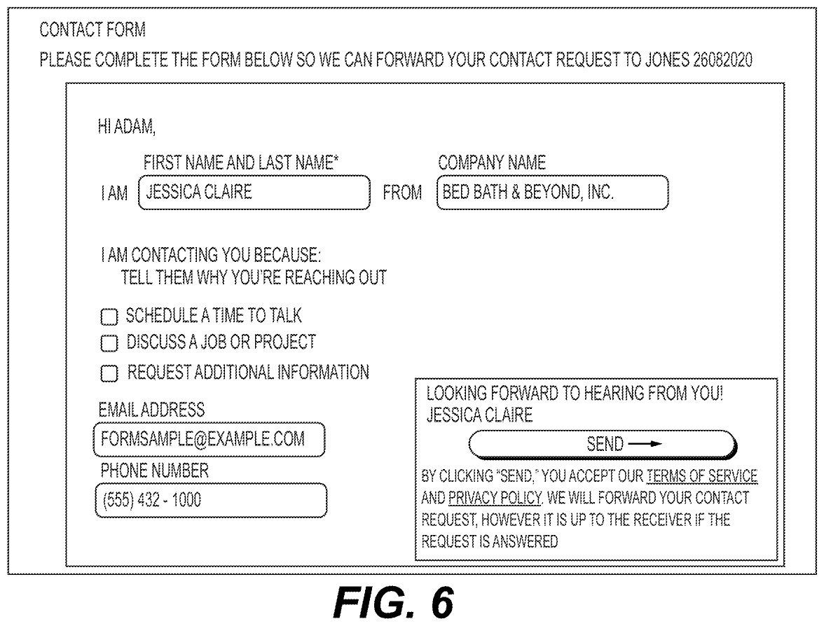

In an embodiment, the system may contain functionality that may enable profile viewers to provide messages to the profile owners. For instance, referring now to FIG. 6, an exemplary contact form is provided. In an embodiment, profile viewing employers that are interested in further communicating with a profile owner may complete the contact form to leave a message and/or to further discuss an opportunity with the profile owner. In an embodiment, the system may be configured to enable profile viewers to leave anonymous messages to profile owners. More particularly, profile viewers may toggle various settings in the contact form (not illustrated) to activate this functionality. For instance, profile viewers may choose to provide comments as a completely anonymous individual or, alternatively, as a partially anonymous individual but with a genericized description of their professional position (e.g., “hiring manager for finance company”, etc.). As a non-limiting example of the foregoing, a hiring manager may anonymously message a candidate that did not receive a job offer to suggest that they obtain additional experience in certain fields, which may improve their chances on a subsequent job listing.

In an embodiment, the system may be capable of conducting various types of skill identification analyses to dynamically determine those aspects of a profile owner's online profile that may be relevant to a particular job listing. More particularly, individuals generally develop a diverse array of skills throughout the course of their life. When looking/applying for jobs, many individuals may be unaware that certain skills they have developed may be transferrable to a position outlined in a job listing, which may correspondingly result in those individuals not applying for that position. Similarly, from a hiring perspective, many employers may overlook candidates that have not obtained a specific degree or that do not have a specific length or type of work experience. This may preclude some candidates that have acquired other relevant skills and experience from being hired. To remedy these oversights, the system of the embodiments may be able to identify these “hidden” skills of a candidate and provide indications to the candidate and/or an employer that the candidate may be a match for a particular position in a job listing. As an example of the foregoing, a job listing may specify that a minimum degree in computer science is needed to be considered for a particular position. Although a sample candidate may not have obtained the minimum degree in computer science, they may have worked extensively with computers for years, thereby providing them with the knowledge and/or experience that is at least equivalent to an individual that has obtained the minimum degree in computer science. The system of the embodiments may be able to dynamically identify these equivalencies and provide relevant indications to the candidate and/or employer, based on analyzing data associated with the candidate (e.g., data contained in the candidate's profile, etc.) and the employer (e.g., data contained in the job listing, the search criteria, etc.).

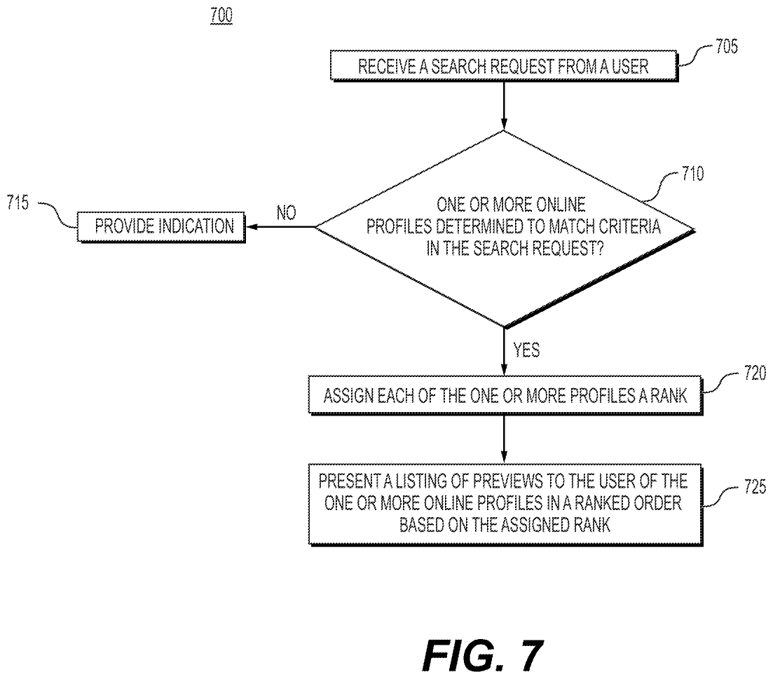

FIG. 7 depicts an exemplary process of searching for online profiles on an application portal, according to one or more embodiments of the present disclosure. The process described in FIG. 7 may be performed by a server hosting the application portal (e.g., the online portal discussed elsewhere in the present disclosure).

At step 705, an indication of a search request provided by a user (i.e., a profile viewer) may be received at an application portal. In an embodiment, the search request may contain both: a category selection and a keyword indication.

At step 710, the application portal may determine whether at least one online profile matches the criteria of the search request. More particularly, a determination may be made whether an online profile both belongs to the selected category and is associated with one or more user-provided keywords. To facilitate this determination, the application portal may have access to and may conduct a search and analysis across a plurality of databases that may contain various types of user data (e.g., online profile data, traditional resume data, “enhanced documents” as described in U.S. Patent Application No. 63/337,887, etc.).

Responsive to determining, at step 710, that no online profiles match the search criteria in the search request, the application portal may provide, at step 715, an indication of the same. For instance, the application portal may provide an indication to the user that no online profiles match their search request. Additionally or alternatively, the application portal may provide a suggestion for the user to modify the criteria in their search request (e.g., adjust the category selection, utilize different keywords, etc.). Conversely, responsive to determining, at step 710, that one or more online profiles match the criteria of the search request, the application portal may assign, at step 720, each of the one or more online profiles a rank.

In an embodiment, the ranking may be assigned utilizing a ranking algorithm that leverages one or more ranking criteria (e.g., keyword match proportion, content robustness indication, subscription status, profile popularity indication, profile publication indication, profile activity indication, etc.) in the ranking calculus. For instance, as a non-limiting example, the one or more online profiles may be ranked based on the robustness of each profile. In this regard, the system may, for each of the one or more online profiles, identify the number of completed sections and/or the volume of information contained within each completed section. Thereafter, the system may assign a higher rank to those profiles containing more completed sections/information.

At step 725, a listing of previews of the one or more online profiles may be provided to the user in a search results screen. In an embodiment, the listing of previews may be presented in a ranked order that is based on the assigned rank. In an embodiment, each of the previews may contain a subset of information that is contained in the full online profile.

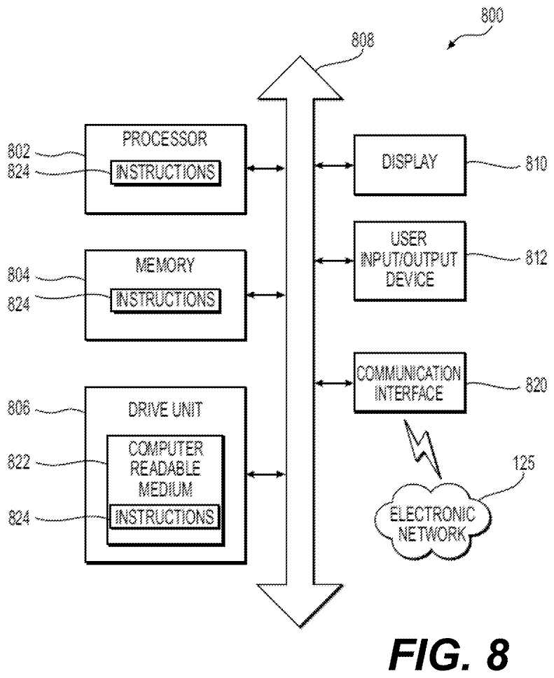

FIG. 8 is a simplified functional block diagram of a computer system 800 that may be configured as a computing device for executing the processes according to exemplary embodiments of the present disclosure. FIG. 8 is a simplified functional block diagram of a computer that may be configured as the computer server according to exemplary embodiments of the present disclosure. In various embodiments, any of the systems herein may be an assembly of hardware including, for example, a data communication interface 820 for packet data communication. The platform also may include a central processing unit (“CPU”) 802, in the form of one or more processors, for executing program instructions. The platform may include an internal communication bus 808, and a storage unit 806 (such as ROM, HDD, SDD, etc.) that may store data on a computer readable medium 822, although the system 800 may receive programming and data via network communications. The system 800 may also have a memory 804 (such as RAM) storing instructions 824 for executing techniques presented herein, although the instructions 824 may be stored temporarily or permanently within other modules of system 800 (e.g., processor 802 and/or computer readable medium 822). The system 800 also may include input and output ports 812 and/or a display 810 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for searching online profiles, the method comprising:
receiving, a search request from a user, wherein the search request comprises a category selection and a keyword indication associated with the category selection;
retrieving, from one or more accessible databases, two or more online profiles that are determined to match the category selection and the keyword indication;
assigning, by utilizing a ranking algorithm, each respective online profile of the two or more online profiles a respective rank based on one or more ranking criteria;
presenting two or more profile previews to the user in a ranked order, wherein each of the two or more profile previews comprises a subset of information contained in the two or more online profiles, and at least a profile owner's name, education history, current location, and top skills; and
presenting to the user, a respective visual indicator proximate to each respective profile preview of the two or more profile previews, wherein the respective visual indicator indicates at least one of a compatibility of the online profile with a job opportunity or a likelihood of a profile owner to be hired for the job opportunity.

2. The computer-implemented method of claim 1, wherein the one or more ranking criteria are selected from a group consisting of: a keyword match proportion, a content robustness indication, a subscription status, a profile popularity indication, a profile publication indication, and a profile activity indication.

3. The computer-implemented method of claim 2, wherein:
the one or more ranking criteria include the content robustness indication, and
assigning the rank based on the content robustness indication comprises:
identifying at least one of a number of completed sections or a volume of information within each of the number of completed sections in each of the two or more online profiles; and
assigning a higher rank to those of the two or more online profiles having a greater number of at least one of the completed sections or the volume of information within each of the number of completed sections.

4. The computer-implemented method of claim 1, further comprising:
receiving, a filter selection on the two or more profile previews, wherein the filter selection comprises a designated criteria; and
narrowing, based on the filter selection, the two or more profile previews to a subset of the two or more profile previews,
wherein each of the subset of the two or more profile previews is associated with one of the two or more online profiles having the designated criteria.

5. The computer-implemented method of claim 1, further comprising:
receiving details associated with the job opportunity;
comparing the details associated with the job opportunity to information contained in the two or more online profiles;
identifying, based on the comparing, a compatibility of each of the two or more online profiles with the job opportunity; and
wherein presenting to the user, the respective visual indicator comprises associating, based on the identified compatibility, the respective visual indicator with each respective of the two or more profile previews.

6. The computer-implemented method of claim 1, further comprising:
detecting, a selection of a view profile icon within one of the two or more profile previews; and
initiating, subsequent to the detecting, an online profile page associated with the one of the two or more profile previews that displays all of the information contained in the one of the two or more online profiles.

7. The computer-implemented method of claim 6, further comprising providing, within the online profile page, at least one option to visit a similar online profile page, wherein the similar online profile page comprises a predetermined amount of similar information as the information contained in the online profile page.

8. The computer-implemented method of claim 6, further comprising:
identifying one or more interactions that the user has with the online profile page;
recording, the one or more interactions; and
providing, based at least on the recorded one or more interactions, a recommendation to a profile owner for how the online profile page can be improved.

9. The computer-implemented method of claim 1, further comprising:
determining, whether the user is associated with a restricted category as designated by the profile owner of one of the two or more online profiles; and
limiting, based on the determining, the user from viewing one or more predetermined activities occurring on the one of the two or more online profiles.

10. The computer-implemented method of claim 1, further comprising:
receiving, from the user, a request to transmit a message to a profile owner of one of the two or more online profiles;
presenting, responsive to receiving the request, a contact form to the user;
identifying one or more inputs provided to the contact form by the user; and
transmitting, subsequent to detecting a selection of a send icon in the contact form, the message containing the one or more inputs to the profile owner.

11. A system for searching online profiles, comprising:
at least one database; and
a server in network communication with the at least one database, the server comprising at least one processor configured to:
receive, a search request from a user, wherein the search request comprises a category selection and a keyword indication associated with the category selection;
retrieve, from one or more accessible databases, two or more online profiles that are determined to match the category selection and the keyword indication;
assign, utilizing a ranking algorithm, each respective online profile of the two or more online profiles a respective rank based on one or more ranking criteria;
present two or more profile previews to the user in a ranked order, wherein each of the two or more profile previews comprises a subset of information contained in the two or more online profiles and at least a profile owner's name, educational history, current location, and top skills; and
present to the user, a respective visual indicator proximate to each respective profile preview of the two or more profile previews, wherein the respective visual indicator indicates at least one of a compatibility of the online profile with a job opportunity or a likelihood of a profile owner to be hired for the job opportunity.

12. (canceled)

13. (canceled)

14. The system of claim 11, wherein the at least one processor is further configured to:
receive details associated with the job opportunity;
compare the details associated with the job opportunity to the information contained in the two or more online profiles;
identify, based on the comparison, the compatibility of each online profile of the two or more online profiles with the job opportunity; and
wherein in order to present the respective visual indicator, the at least one processor is configured to: associate, based on the identified compatibility, the respective visual indicator with each respective profile preview of the two or more profile previews.

15. The system of claim 11, wherein the at least one processor is further configured to:
detect, within one of the two or more profile previews, a selection of a view profile icon; and
initiate, subsequent to the detecting, an online profile page associated with the one of the two or more profile previews that displays all of the information contained in the two or more online profiles.

16. (canceled)

17. (canceled)

18. The system of claim 11, wherein the at least one processor is further configured to:
determine whether the user is associated with a restricted category as designated by a profile owner of one of the one or more online profiles; and
limit, based on the determining, the user from viewing one or more predetermined activities occurring on the one of the one or more online profiles.

19. The system of claim 11, wherein the at least one processor is further configured to:
receive, from the user, a request to transmit a message to a profile owner of one of the two or more online profiles;
present, responsive to receiving the request, a contact form to the user;
identify one or more inputs provided to the contact form by the user; and
transmit, subsequent to detecting selection of a send icon in the contact form, the message containing the one or more inputs to the profile owner.

20. A non-transitory computer-readable medium storing computer-executable instructions which, when executed by at least one processor of a server in network communication with at least one database, cause the at least one processor to perform operations comprising:
receiving a search request from a user, wherein the search request comprises a category selection and a keyword indication;
retrieving, from one or more accessible databases, two or more online profiles that are determined to match the category selection and the keyword indication associated with the category selection;
assigning, utilizing a ranking algorithm, each respective online profile of the two or more online profiles a respective rank based on one or more ranking criteria; and
presenting two or more profile previews to the user in a ranked order, wherein each of the two or more profile previews contains a subset of information contained in the two or more online profiles and at least a profile owner's name, education history, current location, and top skills; and
presenting to the user, a respective visual indicator proximate to each respective profile preview of the two or more profile previews, wherein the respective visual indicator indicates at least one of a compatibility of the online profile with a job opportunity or a likelihood of a profile owner to be hired for the job opportunity.

21. The computer-implemented method of the claim 1, wherein
the respective visual indicator includes a number indicating a compatibility determination.

22. The computer-implemented method of claim 1, wherein the respective visual indicator includes a color indicating a compatibility determination.

23. The computer-implemented method of claim 1, wherein the respective visual indicator includes an emoticon indicating a compatibility determination.

24. The computer-implemented method of claim 1, further comprising presenting a second respective visual indicator proximate to each respective profile preview of the two or more profile previews, wherein the respective visual indicator indicates the compatibility of the online profile with the job opportunity and the second respective visual indicator indicates the likelihood of the online profile to be hired for the job opportunity.
